(19) United States
(12) Patent Application Publication
(10) Pub. No.: US 2017/0098103 A1
(43) Pub. Date: Apr. 6, 2017

(54) INTEGRATED MESSAGE VEILING SYSTEM

(71) Applicant: POP POP LLC, ABERDEEN, NJ (US)

(72) Inventors: FRANK J. CLEMENTE, ABERDEEN, NJ (US); FRANK P. CLEMENTE, BROOKLYN, NY (US)

(21) Appl. No.: 15/382,566

(22) Filed: Dec. 16, 2016

Related U.S. Application Data
(63) Continuation-in-part of application No. 14/523,597, filed on Oct. 24, 2014.
(60) Provisional application No. 61/947,582, filed on Mar. 4, 2014.

(51) Int. Cl. G06F 21/84; H04L 12/58; G06F 21/62; H04L 29/06

(52) U.S. Cl. CPC G06F 21/84; H04L 67/42; H04L 51/08; H04L 51/12; H04L 51/36; G06F 21/6218; G06F 3/04845

(57) ABSTRACT

An integrated veiled message system for securely delivering messages over a communications network. Client devices transmit and receive messages over the communication network. Each client device is network enabled, associated with a user and has a client processor and a screen to compose and display messages. The network router routes each message to the recipient's client device. The client processor of the recipient's client device receives the recipient's message with a puzzle from the sender's client device. The puzzle being selected by the sender which partially or entirely covers the message when displayed on the screen on the recipient's client device. The client processor of the recipient's client device renders and displays the recipient's message and accompanying puzzle on the screen to reveal and display only a portion of the message corresponding to a solved area of the accompanying puzzle

### RELATED APPLICATION

The present application is a continuation-in-part of application Ser. No. 14/523,597 filed Oct. 24, 2014, which claims benefit of Provisional Patent Application Ser. No. 61/947,582 filed Mar. 4, 2014, each of which is incorporated herein by reference in its entirety.

### TECHNICAL FIELD OF THE INVENTION

This invention relates to a message system, more particularly to a system for delivering a veiled message/email/text that requires the recipient to solve a puzzle to unveil the message cover or open a digital envelope to view the message content.

### BACKGROUND OF THE INVENTION

Current methods of transmitting messages, photos, videos, texts, tweets and/or emails (collectively referred to herein as “message” or “messages”) provide no protection against wandering eyes. A third-party can easily view incoming message notifications and the message itself while it is being viewed by the user on her client device, preferably a portable device, such as a smart phone, a tablet and the other communications enabled devices, e.g., Internet, Wi-Fi or Bluetooth enabled devices. BLUETOOTH® is a registered trademark of Bluetooth SIG, Inc. and WI-FI® is a registered trademark of Wi-Fi Alliance Corporation. The messages and/or emails can contain pictures, texts, videos, audios, documents and like.

In order to view the message privately, the user must shield the screen from others or view the message away from the people. This may be a challenge when viewing the message at work, a restaurant, a sporting event, or in a crowded train. That is, messages are delivered to the user's portable device without any cover or digital envelope.

Accordingly, the claimed invention proceeds upon a desirability of delivering the message with a cover or digital envelope that requires the user to “unveil” the cover or open the digital envelope to view the message.

### SUMMARY OF THE INVENTION

Therefore, an object of the claimed invention is to provide a system for delivering a veiled message to user's client device.

Another object of the claimed invention is to provide aforesaid system which requires user to unveil the message cover or open the digital envelope to read the message content.

A further object of the claimed invention is to provide aforesaid system that requires the recipient to erase the message with her finger.

A still another object of the claimed invention is to provide aforesaid system which requires user to solve a puzzle, e.g., a crossword puzzle, a math puzzle, a jigsaw puzzle, a brain teaser, a word decoder, etc., to unveil the message cover or open the digital envelope to read the message content.

In accordance with an exemplary embodiment of the claimed invention, an integrated veiled message system for securely delivering messages over a communications network comprises a plurality of process based client devices and a processor based server. Each client device transmits and receives messages over the communication network, is network enabled, associated with a user and comprises a client processor and a screen to compose and display messages. The server receives and stores the messages from the client devices in a storage device and transmits a message notification to a client device associated with a recipient of each message. The client processor of the recipient's client device accesses and retrieves a recipient's message with a veil from the server over the communications network. The veil is selected by a sender of the recipient's message which partially or entirely covers the message when displayed on the screen on the recipient's client device. The client processor of the recipient's client device renders and displays the recipient's message and accompanying veil on the screen to reveal and display only a portion of the message not covered by the accompanying veil.

In accordance with an exemplary embodiment of the claimed invention, an integrated veiled message system for securely delivering messages over a communications network comprises a plurality of processor based client devices and a router. Each client device transmits and receives messages over the communication network, is network enabled, associated with a user and comprises a client processor and a screen to compose and display messages. The router routes the messages from the client devices to a client device associated with a recipient of each message over the communications network. The client processor of the recipient's client device receives a recipient's message with a veil from the sender's client device over the communications network. The veil is selected by the sender which partially or entirely covers the message when displayed on the screen on the recipient's client device. The client processor of the recipient's client device renders and displays the recipient's message and accompanying veil on the screen to reveal and display only a portion of the message not covered by the accompanying veil.

In accordance with an exemplary embodiment of the claimed invention, the veil comprises at least one of the following: a cover, a digital envelope, a crossword puzzle, a math puzzle, a jigsaw puzzle, a brain teaser, a word decoder, a video and a talking veil, a cartoon, animated video with or without audio, an image, a user created veil, an oral or written question to be answered orally or textually.

In accordance with an exemplary embodiment of the claimed invention, instead of and/or in addition to rendering and displaying the recipient's message and accompanying veil on the screen to reveal and display only a portion of the message not covered by the accompanying veil, the client processor of the recipient's client device covers the portion of the message read by the recipient with the accompanying veil.

In accordance with an exemplary embodiment of the claimed invention, the integrated message veiling system integrates with a social network service and/or website, such as TWITTER®, FACEBOOK®, INSTAGRAM®, LINKEDIN®, TUMBLR®, and SNAPCHAT®.

Various other objects, advantages, and features of the claimed invention will become readily apparent from the ensuing detailed description, and the novel features will be particularly pointed out in the appended claims.

### BRIEF DESCRIPTION OF THE DRAWINGS

The following detailed description, given by way of example, and not intended to limit the claimed invention solely thereto, will best be understood in conjunction with the accompanying drawings in which:

FIG. 1 is a block diagram of the system architecture in accordance with an exemplary embodiment of the claimed invention;

FIG. 2A is a block diagram of a client device in accordance with an exemplary embodiment of the claimed invention;

FIG. 2B is a block diagram of a server in accordance with an exemplary embodiment of the claimed invention;

FIG. 3 is a block diagram of the message composition screen in accordance with an exemplary embodiment of the claimed invention;

FIG. 4 are illustrations of the message content, veiled message and partially unveiled message in accordance with an exemplary embodiment of the claimed invention;

FIG. 5 is illustration of the partially unveiled message in accordance with an exemplary embodiment of the claimed invention;

FIG. 6 is illustration of unveiling of an area of the veiled message in accordance with an exemplary embodiment of the claimed invention;

FIGS. 7A-B are illustration of a veil in the form of a jigsaw puzzle in accordance with an exemplary embodiment of the claimed invention; and

FIG. 8 is illustration of a veil in the form of a math puzzle in accordance with an exemplary embodiment of the claimed invention.

### DETAILED DESCRIPTION OF THE EMBODIMENTS

The term “communications device” or “user device” represents an information processor or device, such as personal digital assistant, web-enabled or communications-enabled device, tablet, laptop, net book, mobile or smart phone, wireless device and other comparable portable devices. Among other things, the communications device can interface with a communications network, such as the wireless network, Wi-Fi, Bluetooth, Internet and the like, to accept a user's input by any means possible. Such means include, but are not limited to, (1) touch, such as a keyboard, touch sensitive surface, pointing device, and the like; (2) sound, such as voice or any other sound; (3) light, in both the visible or not visible spectrum; and (4) any other input means. A “communications device” can also notify a user of received information and display such information by any means, including but not limited to visual, audio, and mechanical motion means.

The term “puzzle” as used herein refers to any veil that requires user to provide an answer or solve “something” to unveil the message cover or open the digital envelope, including but not limited to: a crossword puzzle, a math puzzle, a jigsaw puzzle, a brain teaser, a word decoder, a video and a talking veil, a cartoon, animated video with or without audio, an image, a user created veil, an oral or written question to be answered orally or textually.

The claimed invention is readily implemented by presently available communications apparatus and electronic components. The invention find ready application in virtually all commercial communications networks, including, but not limited to an intranet, a local area network (LAN), a wide area network (WAN), world wide web, a telephone network, a wireless network, and a wired cable transmission system. The communications device can access these communications network using Bluetooth, Wi-Fi and any other comparable means.

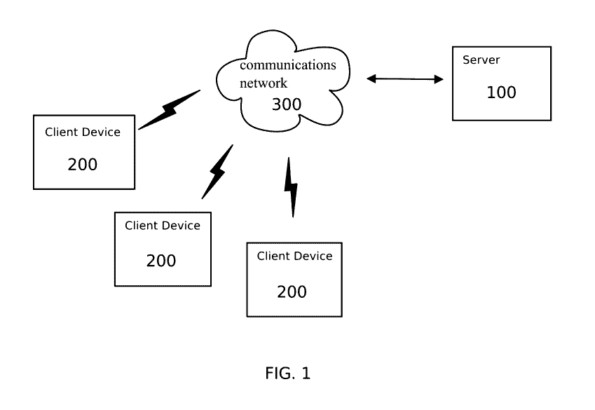

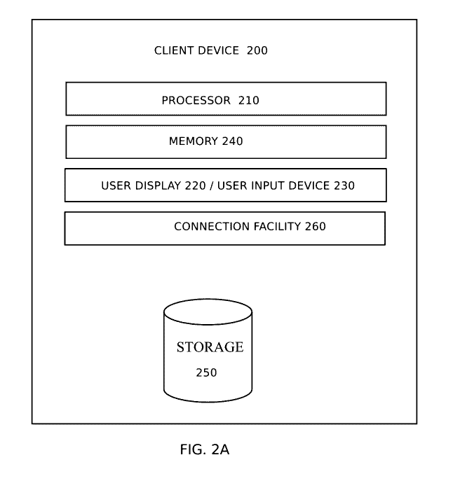

As shown in FIG. 1, at the system level, the claimed invention comprises one or more web-enabled processor based client devices 200, one or more processor based servers 100, and a communications network 300 (e.g., wireless network). In accordance with an exemplary embodiment of the claimed invention, as shown in FIG. 2A, each client device 200 comprises a processor or client processor 210, a display or screen 220, an input device 230 (which can be the same as the display 220 in the case of touch screens), a memory 240, a storage device 250 (preferably, a persistent storage, e.g., hard drive), and a connection facility 260 to connect to the communications network 300.

In accordance with an exemplary embodiment of the claimed invention, the server 100 comprise a processor or server processor 110, a memory 120, a storage device 130 (preferably a persistent storage, e.g., hard disk, database, etc.), a connection facility 140 to connect to the communications network 300, an optional graphics processor 150.

The network enabled client device 200 includes but is not limited to a computer system, a personal computer, a laptop, a notebook, a netbook, a tablet or tablet like device, an IPad® (IPAD is a registered trademark of Apple Inc.) or IPad like device, a cell phone, a smart phone, a personal digital assistant (PDA), a mobile device, or a television, or any such device having a screen connected to the communications network 300 and the like.

The communications network 300 can be any type of electronic transmission medium, for example, including but not limited to the following networks: a telecommunications network, a wireless network, a virtual private network, a public internet, a private internet, a secure internet, a private network, a public network, a value-added network, an intranet, a wireless gateway, or the like. In addition, the connectivity to the communications network 300 may be via, for example, by cellular transmission, Ethernet, Token Ring, Fiber Distributed Datalink Interface, Asynchronous Transfer Mode, Wireless Application Protocol, or any other form of network connectivity.

In accordance with an exemplary embodiment of the claimed invention, the inventive system for transmitting veiled messages is now described herein from the perspective of two users: a message sender (i.e., sender) and a message recipient (i.e., receiver). Messages, photos, videos, texts, tweets and/or emails are interchangeable and collectively referred to herein as “message” or “messages.” The sender generates a message using her client device 200 (hereinafter the “sender's client device 200). After the message has been created, a notification is sent to the recipient's client device 200 over the communications network. Depending on the embodiment employed by the system, the notification can be sent by the sender's client processor 210 via the connection facility 260 of the sender's client device 200 or the server processor 110 via the connection facility 140.

In accordance with an exemplary embodiment of the claimed invention, the message contents are stored on the server 100, preferably in the storage or database 130, until the recipient's client device 200 requests or retrieves them from the server 100. Alternatively, the sender's client processor 210 can send the message contents directly to the recipient's client device 200 over the communications network 300 via the connection facility 260, thereby bypassing the server 100. In such embodiment, the server 100 acts as a network router or can be replaced with a network router to route the message and/or the notification from the sender's client device 200 to the recipient's client device 200.

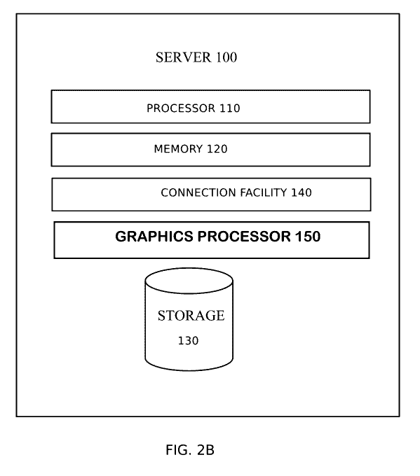

In accordance with an exemplary embodiment of the claimed invention, as shown in FIG. 3, each sender's client device 200 comprises a set of graphical user interfaces (GUIs) or screens which are shown on the display 220 for composing, editing and sending messages. The client processor 210 displays an arrangement of the various GUIs or screens, e.g., a composition screen 400, on the display 220 of the sender's client device 200, which can include user interface elements to enable the user/sender to perform various tasks, e.g., composing, editing and sending messages, using the her input device 230 or the touch screen 220. In accordance with an exemplary embodiment of the claimed invention, the client processor 210 combines the message composition and message display options onto a single composition screen 400 on the user display 220, as exemplary shown in FIG. 3, but it is appreciated that they can be placed on two separate screens. As exemplary shown in FIG. 3, the single composition screen 400 can consist of a text input area 410 which is configured to be roughly the size of a typical message, and an “Options” button 420 underneath the text input area 410.

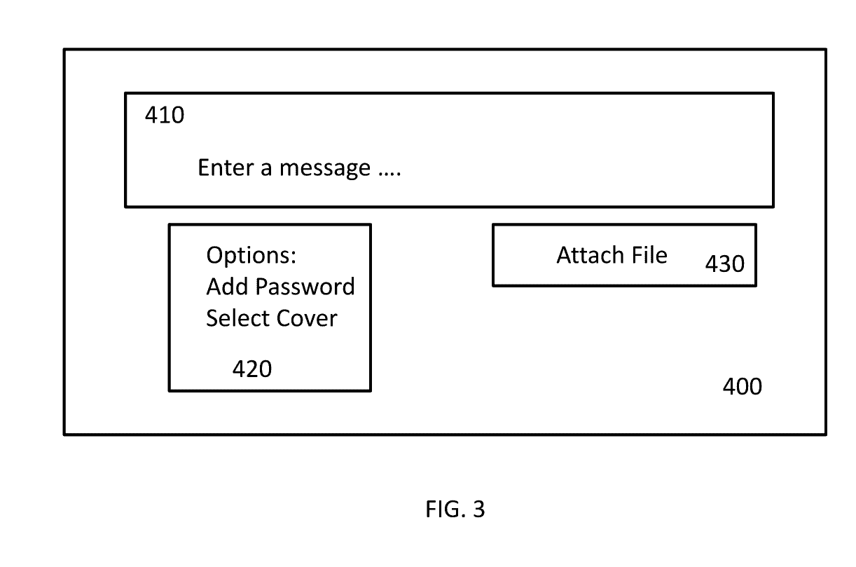

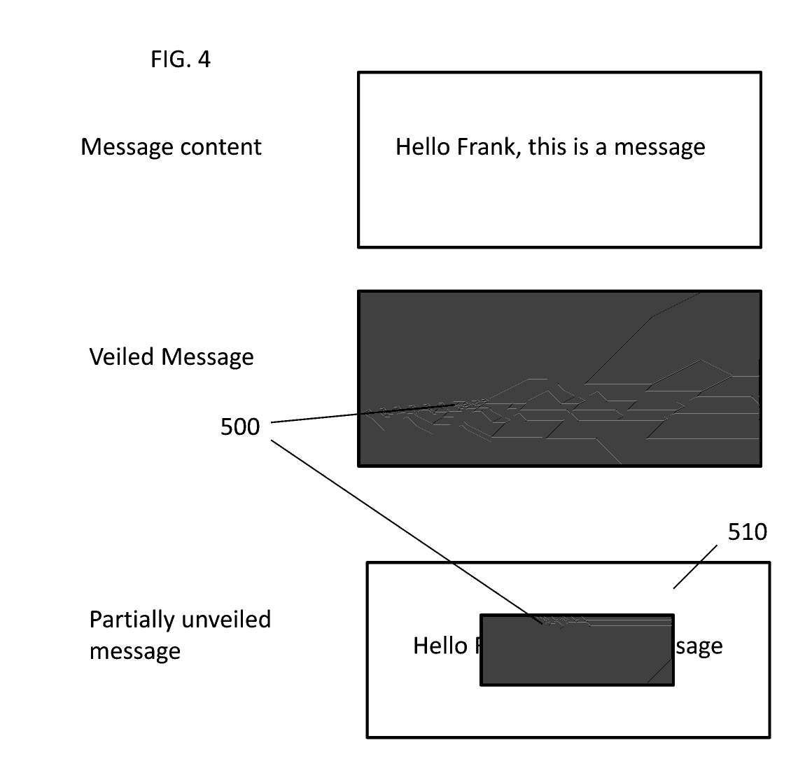

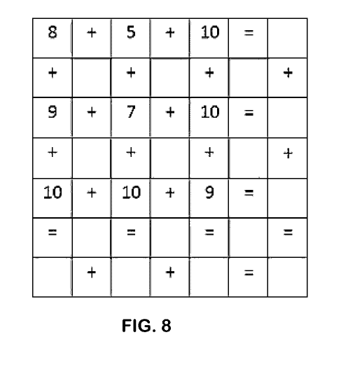

When the client processor 210 generates a new message based on the input received by the sender's client device 200 from the sender via the input device 230, the server processor 110 performs and/or the sender's client processor 210 additionally performs various tasks to package the message for use in the claimed system. In accordance with an exemplary embodiment of the claimed invention, the sender selects, using the GUIs displayed on the display 220 of her client device 200, the details as to how the message is to be displayed (e.g., unveiled, fully veiled or partially veiled, as exemplary shown in FIGS. 4-8) on the recipient's client device 200. The client processor 210 stores the sender's selection in the message as metadata containing information about the size of the message, thereby enabling the client processor 210 of the recipient's client device 200 to display a representation of the sender's message that is the correct size on the display 220 of the recipient device 200. The client processor 210 of the sender's client device 200 also stores the recipient information specified by the sender in the message. Preferably, the client processor 210 of the sender's client device 200 stores the message and accompanying metadata in the memory 240 and/or the storage device 250.

In accordance with an exemplary embodiment of the claimed invention, the client processor 210 displays GUIs (e.g., the composition screen 400) on the screen 220 of the sender's client device 200 to permit the sender to set the settings which effect how the recipient will interact with the message using her input device 230 or her touch screen 220. The client processor 210 displays the composition screen 400 displayed on the screen 220 of the sender's client device 200, which includes the “Options” button 420 and “Attach File” button 430 below the message text input area 410, as exemplary shown in FIG. 3. When the Options button 420 is clicked by the sender using her input device 230 (or touch screen 220), the client processor 210 of the sender's client device 200 presents a display options for controlling the display of the message on the screen 220 of the recipient's client device 200 and setting various message display control options on the screen 220. The sender may require the recipient to enter a password to unveil the message, “erase” the message cover 510 to open the message, to solve a puzzle, answer a question, or display the message for a predetermined time. The sender may assign different veils or covers 500 to different recipients or different groups of recipients, such that the client processor 210 always uses a specific veil or cover 500 assigned to a recipient or a group of recipient for all messages sent to that specific recipient or that specific group of recipients. The client processor 210 stores the message display control options selected by the sender in memory 240 and/or storage 250 of the sender's client device 200.

In accordance with an exemplary embodiment of the claimed invention, the sender's client device 200 accesses the server 100 over the communications network 300 via the connection facilities 260, 140. The server processor 110 and/or the client processor 210 of the sender's client device 200 displays the GUIs (e.g., the composition screen 400) on the screen 220 of the sender's client device 200 to permit the sender to set the settings which effect how the recipient will interact with the message using her input device 230 or her touch screen 220. The composition screen 400 includes “Options” button 420 and “Attach File” button 430 below the message text input area 410, as exemplary shown in FIG. 3. When the Options button 420 is clicked by the sender using her input device 230 (or touch screen 220), the server processor 110 presents a display options for controlling the display of the message on the screen 220 of the recipient's client device 200 and setting various message display control options on the screen 220. The sender may require the recipient to enter a password to unveil the message, “erase” the message veil or cover 500 to open the message, to solve a puzzle, answer a question, or display the message for a predetermined time. The client processor 210 transmits the message display control options selected by the sender to the server 100 over the communications network 300 via the connection facility 260. The server processor 210 stores the message display options selected by the sender in server memory 120 and/or storage device 130. Alternatively or in addition, the client processor 210 stores the message display control options selected by the sender in memory 240 and/or storage 250 of the sender's client device 200.

It is appreciated that default display options values are used and sent with the message when sender does not change these display options or control settings. That is, in accordance with an exemplary embodiment of the claimed invention, the server processor 110 and/or the client processor 210 of the sender's client device can automatically sent a default veil or cover 500 with all messages. The default veil or cover 500 can be fixed for a particular recipient, a particular group of recipients, for a predetermined period of time (e.g., the default cover 500 is changed every day or every hour). Generally, the senders do not bother to change these default display control/options settings, so the system operator should select default values that best represent the expected use of their system. Alternatively, the sender can create or draw a new cover 500, e.g., create a puzzle using a built-in puzzle generator or using a third party puzzle generator, customize an existing cover 500, download covers 500 from the Internet, use puzzles, photos or videos downloaded from the Internet, taken by the sender's client device 100 equipped with a camera or previously stored in the storage device 250 of the sender's client device as veils/covers 500. The sender can store a library of veils or covers 500 in the storage device 250 of the sender's client device 200 or the storage device 130 of the server 100.

In accordance with an exemplary embodiment of the claimed invention, the sender can choose the message display format to be used in displaying her message contents on the screen 220 of the recipient's client device 200. In accordance with an exemplary embodiment of the claimed invention, the client processor 210 of the sender's client device 200 displays GUIs on the screen 220 in the form of a drop down menu which lists one or more display formats (e.g., unveiled, fully veiled or partially veiled format) and/or one or more display option (e.g., unveil to read the content of the message or veil the content read by the user) that can be selected by the sender using her input device 230 or her touch screen 220. If the sender selects either a fully veiled or partially veiled message format, the client processor 210 requests the sender to further select a veil 500, a cover 500 or an envelope 500 (collectively referred to herein as the cover or veil 500) by activating or clicking on the Options button 420 on the composition screen 400 using her input device 230 or her touch screen 220. The client processor 210 displays a plurality of covers/envelopes 500 on the screen 220 of the sender's client device 200. Alternatively, the sender can customize the cover/envelope 500 by uploading her own veil/cover/envelope 500, such as a puzzle/picture/logo/design stored in the storage device 250 of the sender's client device 200, by activating or clicking on the Attach File button 430 on the composition screen 400 using her input device 230 or her touch screen 220. In certain embodiments, the service provider may automatically select a default cover/envelope 500 for all messages, e.g., a company logo, a professional sport team's logo, a college mascot, etc.

In accordance with an exemplary embodiment of the claimed invention, the sender's client device accesses the server 100 over the communications network 300 via the connection facilities 260,140 to enable the sender to choose the message display format and/or display option to be used in displaying her message contents on the screen 220 of the recipient's client device 200. The server processor 110 and/or the client processor 210 of the sender's client device 200 displays GUIs on the screen 220 in the form of a drop down menu which lists one or more display formats (e.g., unveiled, fully veiled or partially veiled format) and/or one or more display option (e.g., unveil to read the content of the message or veil the content read by the user) that can be selected by the sender using her input device 230 or her touch screen 220. If the sender selects either a fully veiled or partially veiled message format, the server processor 110 and/or the client processor 210 requests the sender to further select a cover 500 or an envelope 500 by activating or clicking on the Options button 420 on the composition screen 400 using her input device 230 or her touch screen 220. The server processor 110 and/or the client processor 210 displays a plurality of covers/envelopes 500 on the screen 220 of the sender's client device 200. Alternatively, the sender can customize the cover/envelope 500 by uploading her own cover/envelope 500, such as a puzzle/picture/logo/design stored in the storage device 250 of the sender's client device 200 to the server 100, by activating or clicking on the Attach File button 430 on the composition screen 400 using her input device 230 or her touch screen 220.

In accordance with an exemplary embodiment of the claimed invention, as exemplary shown in FIG. 3, the sender can add a password to the message by activating or clicking on the Options button 420 on the composition screen 400 using her input device 230 or her touch screen 220. If the sender has selected the password add option, then the recipient must enter the password on her client device 200 before she can unveil the cover/envelope to view the message.

In accordance with an exemplary embodiment of the claimed invention, the sender can select a question as a veil/cover 500 by activating or clicking on the Options button 420 on the composition screen 400 using her input device 230 or her touch screen 220. If the sender has selected the question add option, then the recipient must provide either oral/verbal or written answer to either an oral/verbal or written question using or on her client device 200 before she can unveil the cover/envelope to view the message.

In accordance with an exemplary embodiment of the claimed invention, the sender can select a puzzle as a veil/cover 500 by activating or clicking on the Options button 420 on the composition screen 400 using her input device 230 or her touch screen 220. If the sender has selected the puzzle add option, then the recipient must solve the puzzle on her client device 200 before she can unveil the cover/envelope to view the message.

In accordance with an exemplary embodiment of the claimed invention, as exemplary shown in FIG. 3, the sender can activate or click on the Attach File button 430 on the composition screen 400 using her input device 230 or her touch screen 220 to attach one or more of the following files to the message: a document file, an image file, an audio file, a video file, etc.

As exemplary shown in FIGS. 4-6, the recipient's client device 200 displays the message either in unveiled, partially veiled or fully veiled format. That is, in partial or full veiled format, the message displayed on the screen 220 of the recipient's client device 200 is partially or fully covered by a digital cover or envelope 500. When the recipient views a message on the recipient's client device 200, preferably using a client application downloaded from service provider's website, the client processor 210 of the recipient's client device 200 displays the message on the screen 220 based on the format selected by the sender of the message, such as one of the following formats described herein: unveiled, partially unveiled or fully unveiled. It is appreciated that any other comparable message formats can be utilized by the claimed invention to display the message on the recipient's client device 200.

In accordance with an exemplary embodiment of the claimed invention, as shown in FIG. 4, the server processor 110 and/or the client processor 210 of the recipient's device 200 displays the sender's message on the screen 220 of the recipient's client device 200 to prevent others in physical proximity to the recipient from seeing the message contents. It is appreciated that the claimed system of displaying the message in partial or full veiled format is applicable to text, photo, video, other rich media message contents or any screen-displayable message contents to protect against viewing of the message by another person in the close vicinity to the recipient.

In accordance with an exemplary embodiment of the claimed invention, when the message is delivered to a recipient who is not registered with the service provider or to a recipient's client device 200 without the service provider's client application, a link to the service provider's web site or a third-party web site where the recipient can download the application is displayed with the partially or fully veiled message on the screen 220 of the recipient's client device 200. The veiled cover or envelope 500 prevents the message content from being visible to the recipient.

In accordance with an exemplary embodiment of the claimed invention, the client processor 210 client application running on the recipient's device 200 enables the recipient to set the reading option, such as unveil the message after a predetermined time, or one click/touch unveiling of the message. That is, in the one touch/click unveil reading mode, the server processor 110 and/or client processor 210 of the recipient's client device 200 unveils the partially or fully veiled message when the recipient clicks on the cover/envelope 500 displayed on her screen 220 with her input device 230 (e.g., a mouse button). On client device 200 equipped with the touch screen device 200 (e.g., a smart phone or tablet), in accordance with an exemplary embodiment of the claimed invention, the recipient can touch the cover/envelope 500 on the touch screen 220 with her finger to unveil the message content in the one touch/click unveil mode setting.

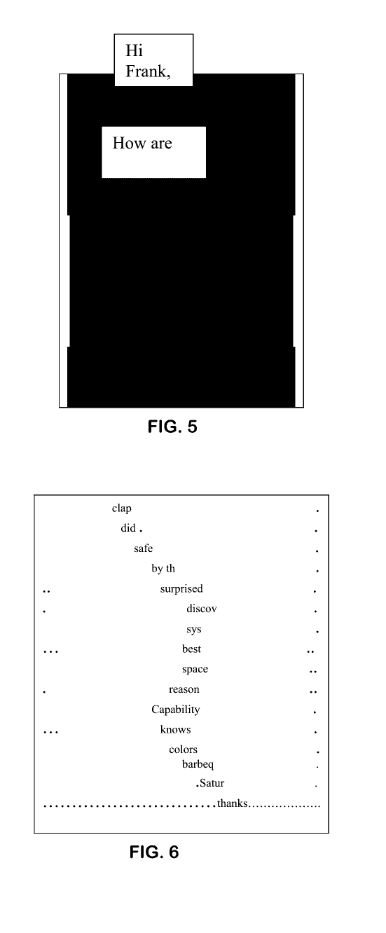

In accordance with an exemplary embodiment of the claimed invention, in the scratch/erase reading mode, the server processor 110 and/or the client processor 210 of the recipient's client device 200 unveils an area of the cover 500 on the touch screen 220 scratched, erased or touched by the recipient's finger as exemplary shown in FIG. 6. On a client device 200 without the touch screen 220, in accordance with an exemplary embodiment of the claimed invention, the server processor 110 and/or the client processor 210 of the recipient's client device 200 unveils an area of the cover 500 scratched or erased by an input device 230, e.g., a mouse 230. As exemplary shown in FIGS. 4-6, the recipient can see a portion of the message that is displayed underneath the unveiled area 510 of the cover 500 but the recipient cannot see the portion of the message still veiled by the remaining portion of the cover 500. The recipient can move her input device 230 or can move her finger(s) to unveil/erase/scratch a new area of the cover 500 displayed on her screen 220 to view additional portion/section of the message.

In accordance with an exemplary embodiment of the claimed invention, the client processor 210 client application running on the recipient's device 200 enables the recipient to set the Q/A option, such as unveil the message after question is answered either orally (verbal answer is provided using the microphone of the recipient's device or textually (textual answer is entered using the input device (e.g., physical or virtual keyboard) of the recipient's device 200).

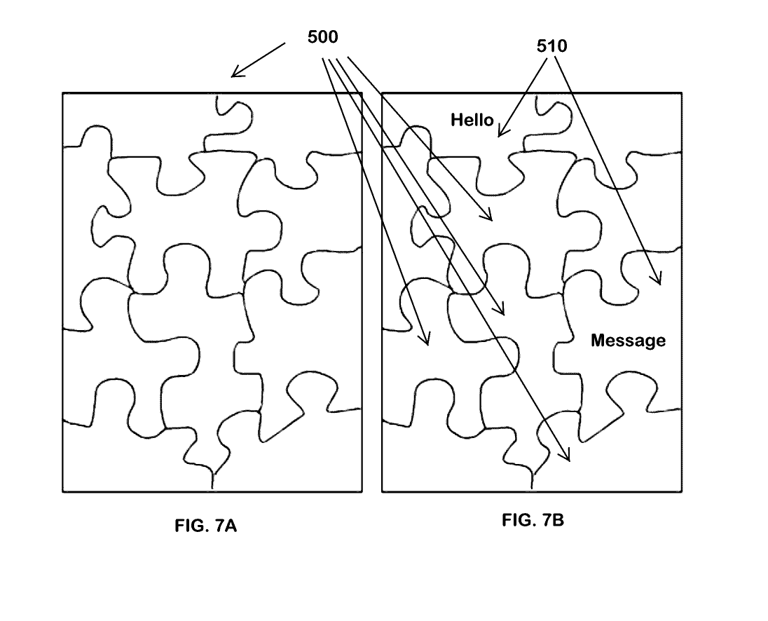

In accordance with an exemplary embodiment of the claimed invention, in the puzzle mode, the server processor 110 and/or the client processor 210 of the recipient's client device 200 unveils an area of the puzzle/cover/veil 500 on the screen or touch screen 220 solved by the recipient, as shown in FIGS. 7A-B. As shown in FIG. 7B, the recipient can see a portion of the message that is displayed underneath the unveiled area 510 of the puzzle 500 but the recipient cannot see the portion of the message still veiled by the unsolved portion of the puzzle 500. The recipient can move her input device 230 or can move her finger(s) to solve the veiled/unsolved portion of the puzzle 500 displayed on her screen 220 to view additional portion/section of the message.

In accordance with an exemplary embodiment of the claimed invention, in the delayed reading mode, the server processor 110 and/or the client processor 210 of the recipient's client device 200 unveils the cover 500 after the fully/partially veiled message has been displayed on the recipient's screen 220 for a predetermined time. It is appreciated that the server processor 110 and/or the client processor 210 of the recipient's client device 200 utilizes the default time, e.g., 5 seconds, unless the predetermined time is set or changed by the recipient, e.g., 4 seconds, 30 seconds, 1 minute, etc.

In accordance with an exemplary embodiment of the claimed invention, in the countdown reading mode, the server processor 110 and/or the client processor 210 of the recipient's client device 200 unveils the cover 500 on her screen 220 after a countdown from a predetermined number. It is appreciated that the server processor and/or the client processor 210 of the recipient's client device 200 counts down from a default number, e.g., ten (10), unless a countdown number is set or changed by the recipient, e.g., five (5).

In accordance with an exemplary embodiment of the claimed invention, the client processor 210 and/or the server processor 110 generates the puzzle 500 that the recipient must solve to unveil the message. The puzzle 500 includes but is not limited to a crossword puzzle, a math puzzle, a jigsaw puzzle, a brain teaser, a word decoder, a video and a talking veil, a cartoon, animated video with or without audio, an image, a user created veil, an oral or written question to be answered orally or textually.

Various omissions, modifications, substitutions and changes in the forms and details of the device illustrated and in its operation can be made by those skilled in the art without departing in any way from the spirit of the present invention. Accordingly, the scope of the invention is not limited to the foregoing specification, but instead is given by the appended claims along with their full range of equivalents.

1. An integrated veiled message system for securely delivering messages over a communications network, comprising:
a plurality of processor based client devices to transmit and receive messages over the communication network, each client device is network enabled, associated with a user and comprises a client processor and a screen to compose and display messages;
a processor based server to receive and store messages from the plurality of client devices in a storage device, and to transmit a message notification to a client device associated with a recipient of each message;
wherein the client processor of the client device associated with the recipient accesses and retrieves a recipient's message with a puzzle from the server over the communications network, the puzzle being selected by a sender of the recipient's message which partially or entirely covers the message when displayed on the screen on the recipient's client device; and
wherein the client processor of the recipient's client device renders and displays the recipient's message and accompanying puzzle on the screen to reveal and display only a portion of the message corresponding to a solved area of the accompanying puzzle.

2. The integrated veiled message system of claim 1, wherein the client processor of a sender's client device associated with the sender displays a graphical user interface (GUI) on a screen of the sender's client device to permit user to compose content of the recipient's message and to select the accompanying puzzle.

3. The integrated veiled message system of claim 2, wherein the client processor of the sender's client device displays the GUI on the screen of the sender's client device to enable user to customize an existing puzzle or create a new puzzle.

4. The integrated veiled message system of claim 2, wherein the client processor of the sender's client device displays a plurality of puzzles on the screen of the sender's client device and transmits a selected puzzle as the accompanying puzzle.

5. The integrated veiled message system of claim 2, wherein the client processor of the sender's client device selects a default puzzle as the accompanying puzzle.

6. The integrated veiled message system of claim 2, wherein the server comprises a server processor to generate the accompanying puzzle from a picture, a logo or design uploaded by the client processor of the sender's client device.

7. The integrated veiled message system of claim 2, wherein the client processor of the sender's client device attaches at least one of the following received from the sender via an input device or a touch screen of the sender's client device to the recipient's message: a document, an image, an audio file or a video file.

8. The integrated veiled message system of claim 1, wherein the message is one of the following: an email, a text, a tweet, a photo, a video or a message.

9. The integrated veiled message system of claim 1, wherein the accompanying puzzle is one of the following: a crossword puzzle, a math puzzle, a jigsaw puzzle, a brain teaser, a word decoder, an oral or written question to be answered orally or textually.

10. The integrated veiled message system of claim 1, wherein the client processor of the recipient's client device veils a viewed portion of the message.

11. An integrated veiled message system for securely delivering messages over a communications network, comprising:
a plurality of processor based client devices to transmit and receive messages over the communication network, each client device is network enabled, associated with a user and comprises a client processor and a screen to compose and display messages;
a router to route the messages from the plurality of client devices to a client device associated with a recipient of each message over the communications network;
wherein the client processor of the client device associated with the recipient receives a recipient's message with a puzzle from a client device associated with a sender of the recipient's message over the communications network, the puzzle being selected by the sender which partially or entirely covers the message when displayed on the screen on the recipient's client device; and
wherein the client processor of the recipient's client device renders and displays the recipient's message and accompanying puzzle on the screen to reveal and display only a portion of the message corresponding to a solved area of the accompanying puzzle.

12. The integrated veiled message system of claim 11, wherein the client processor of a sender's client device associated with the sender displays a graphical user interface (GUI) on a screen of the sender's client device to permit user to compose content of the recipient's message and to select the accompanying puzzle.

13. The integrated veiled message system of claim 12, wherein the client processor of the sender's client device displays the GUI on the screen of the sender's client device to enable user to customize an existing puzzle or create a new puzzle.

14. The integrated veiled message system of claim 12, wherein the client processor of the sender's client device displays a plurality of puzzles on the screen of the sender's client device and transmits a selected puzzle as the accompanying puzzle.

15. The integrated veiled message system of claim 12, wherein the client processor of the sender's client device selects a default puzzle as the accompanying puzzle.

16. The integrated veiled message system of claim 12, wherein the client processor of the sender's client device generates the accompanying puzzle from a stored picture, a logo or design.

17. The integrated veiled message system of claim 12, wherein the client processor of the sender's client device attaches at least one of the following received from the sender via an input device or a touch screen of the sender's client device to the recipient's message: a document, an image, an audio file or a video file.

18. The integrated veiled message system of claim 11, wherein the message is one of the following: an email, a text, a tweet, a photo, a video or a message.

19. The integrated veiled message system of claim 11, wherein the accompanying puzzle is one of the following: a crossword puzzle, a math puzzle, a jigsaw puzzle, a brain teaser, a word decoder, an oral or written question to be answered orally or textually.

20. The integrated veiled message system of claim 11, wherein the client processor of the recipient's client device veils a viewed portion of the message.
